(19) United States
(12) Patent Application Publication
(10) Pub. No.: US 2008/0012959 A1
(43) Pub. Date: Jan. 17, 2008

(54) APPARATUS AND METHOD FOR ADJUSTING WHITE BALANCE

(75) Inventor: Yong-Hyun PARK, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/775,703

(22) Filed: Jul. 10, 2007

(30) Foreign Application Priority Data
Jul. 11, 2006 (KR) 2006-0064798

(51) Int. Cl. H04N 9/73

(52) U.S. Cl. 348/223.1; 348/E09.052

(57) ABSTRACT

Provided are an apparatus and a method for adjusting a white balance. The apparatus includes an image processor processing an image obtained from a subject; a controller controlling the image processor and setting a white balance value according to an input signal of a user; and a lens cover protecting a portion of the image processor and used as a compensating filter when the custom white balance is adjusted.

### PRIORITY

This application claims priority under 35 U.S.C. §119 to an application filed in the Korean Intellectual Property Office on Jul. 11, 2006 and assigned Serial No. 2006-64798, the contents of which are incorporated herein by reference.

### BACKGROUND OF THE INVENTION

1. Field of the Invention

The present invention relates generally to an apparatus and a method for adjusting a white balance applied to various image apparatuses, and in particular, to an apparatus and a method for adjusting a custom white balance without an additional white balance correcting card or filter.

2. Description of the Related Art

In general, image photographing apparatuses, such as cameras, can be classified into film cameras and digital cameras depending on whether media storing photographed images are films or electronics storage media such as charged-coupled devices (CCDs) or complementary metal oxide semiconductors (CMOSs). Also, cameras can be classified into still and moving picture cameras depending on whether they have functions of photographing moving pictures.

Most digital cameras have white balance adjusting functions. Here, white balance refers to a function of adjusting a digital camera to accurately recognize a white color when the digital camera performs photographing based on the white color. In more detail, light has a specific color which is called a color temperature and expressed in units of degrees Kelvin (°K.). If a landscape is illuminated by light having a specific color temperature, humans automatically adjust sensitivity to colors. Thus, humans do not differently recognize the colors. However, in a case of cameras, color temperatures are reflected on colors, and cameras are greatly affected by external light sources. For example, since sunlight has a high color temperature during mid-day, a color is wholly seen as a blue color. Since sunlight has a low color temperature at sunrise or sunset, the color is wholly seen as a red color. If photographing is performed without any processing in this case, a color is wholly changed into a blue color and then into a red color due to the color temperature of a light source.

Users can select and designate color temperatures in most digital cameras according to various conditions, e.g., select and designate sunlight, a cloudy day, evening time, an incandescent lamp, a fluorescent lamp, or shade. Digital cameras also have auto white balance functions for automatically adjusting white balances without any designation using sensors. Moreover, digital cameras for specialists provide users with functions of directly designating predetermined color temperatures as numerical values. However, the surroundings are not formed of only a single light source. For example, fluorescent and incandescent lamps can light up a room and sunlight can come from a window crack into the room, i.e., the room is formed of a compound light source. Thus, it is impossible to set an accurate color temperature in the room.

Many digital cameras have custom white balance functions widely known as preset modes in consideration of the above-described problem. Such a custom white balance function allows a camera to set a reference of a white color and perform R, G, and B color balance operations based on the white color under photographing conditions including various light sources. The custom white balance generally measures an exposure using a gray surface of a gray card having a reflection value of 18% and photographs a white surface of a white card so as to set the measurement results to preset values of the camera.

However, the white card is formed of paper (pulp), and there are various kinds of whites and grays. Thus, it is substantially impossible to accurately adjust a white balance, and it is difficult to measure an accurate white balance value due to discoloration appearing after a long time. In addition, since the white card is carried separately from an image photographing apparatus, the white card is constantly exposed to dangers such as losing the card.

### SUMMARY OF THE INVENTION

An aspect of the present invention is to substantially solve at least the above problems and/or disadvantages and to provide at least the advantages below. Accordingly, an aspect of the present invention is to provide an apparatus and a method for adjusting a custom white balance to improve a picture quality of an image photographing apparatus.

Another aspect of the present invention is to provide an apparatus and a method for adjusting a custom white balance by which a user can directly adjust the custom white balance according to the surroundings to be provided with a high quality image at all times.

A further aspect of the present invention is to provide an apparatus and a method for adjusting a custom white balance using a white balance adjusting lens cover which is not altered after being used for a long time and is installed as a component of an image photographing apparatus to prevent losing the cover due to being carried separately.

According to one aspect of the present invention, there is provided an apparatus for adjusting a custom white balance, including an image processor for processing an image obtained from a subject; a controller for controlling the image processor and setting a white balance value according to an input signal of a user; and a lens cover for protecting a portion of the image processor and used as a compensating filter when the custom white balance is adjusted.

The image processor may include an optical system processing light flowing from the subject; a complementary metal-oxide semiconductor (CMOS) transforming the image input from the optical system into an electrical analog signal; a correlation double sampler and analog-to-digital converter (CDS-ADC) converting the electrical analog signal into a digital signal; and a digital signal processor (DSP) processing the digital signal to generate luminance and chromaticity signals.

According to another aspect of the present invention, there is provided a method of adjusting a custom white balance using the apparatus, including checking whether a signal for adjusting a preset white balance (PWB) is input; if the signal is input, closing the lens cover; and obtaining image data through a subject and setting improved white balance data using the obtained image data.

According to a further aspect of the present invention, there is provided a method of adjusting a custom white balance of an apparatus including a manually operated lens cover having a white balance adjusting filter, including checking whether a signal for adjusting a PWB is input; if the signal is input, checking whether the lens cover is opened or closed; and if the lens cover is closed over the lens unit, obtaining image data through a subject and setting improved white balance data using the obtained image data.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a digital camera to which a lens cover according to the present invention is applied;

FIG. 2 is a block diagram of the digital camera of FIG. 1;

FIG. 3 is a flowchart of a method of adjusting a custom white balance according to the present invention; and

FIG. 4 is a perspective view of a rear appearance of a portable terminal to which a lens cover, according to the present invention is applied.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a camera which can be applied to various types of image photographing apparatuses such as still cameras, moving picture cameras, and digital camera modules, which are installed in a portable terminal to realize multi-functions.

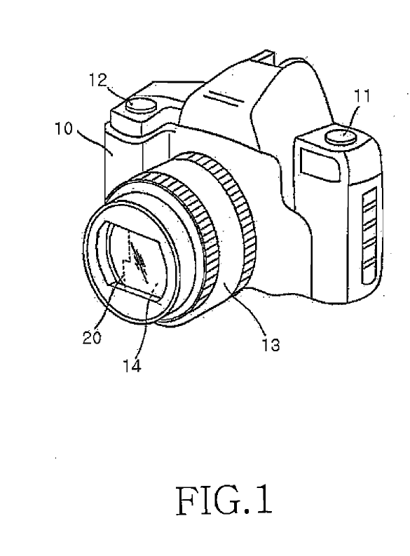

FIG. 1 is a perspective view of a digital camera to which a lens cover 14 according to the present invention is applied. The digital camera includes a body 10 and a tube 13 which protrudes from the body 10 forward and includes a plurality of lens groups. A shutter button 12 is provided on an upper surface of the body 10 to photograph a subject. A preset white balance (PWB) button 11 is provided on a side of the body 10 to perform a custom white balance function according to the present invention. As will be described below, a plurality of lens groups 20 are installed in the tube 13, and the lens cover 14 is installed at an outermost portion of the tube 13 to protect the plurality of lens groups 20 when the digital camera is not used. If a power button (not shown) of the digital camera is powered on, the lens cover 14 may be automatically opened. If the power button is powered off, the lens cover 14 may be automatically closed.

A white balance adjusting card of the present invention, i.e., a filter performing the same function as a conventional gray card, may be installed in the lens cover 14. The lens cover 14 may be formed of a liquid crystal display (LCD) light guide plate capable of adjusting a known reflection distribution and intensity and quantity of light, instead of the conventional plastic material or a metal plate. In other words, the lens cover 14 may be formed of the LCD light guide plate, and the LCD light guide plate may have a light reflectance of 18% like the conventional gray card, which has a reflectance of about 18%.

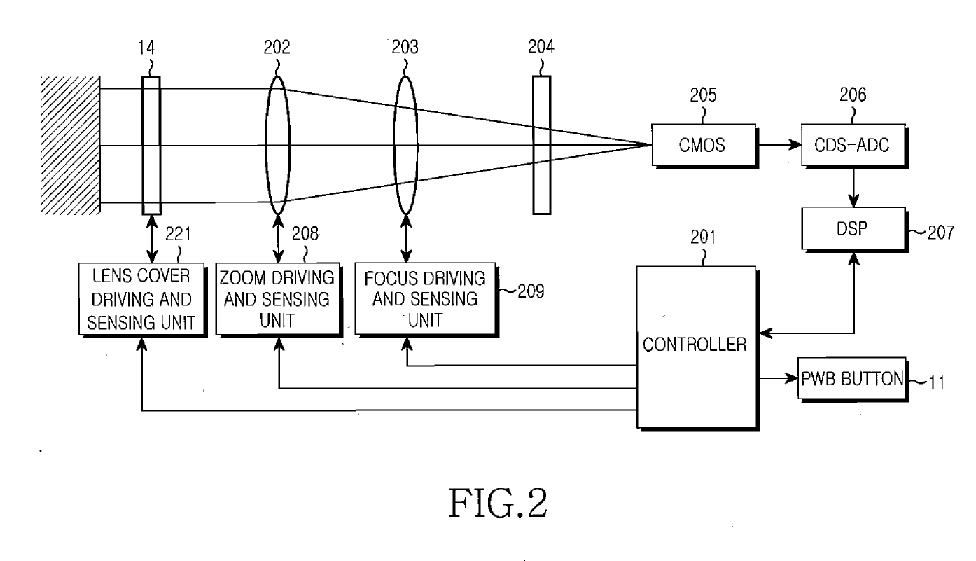

FIG. 2 is a block diagram of the digital camera of FIG. 1.

The digital camera (an image photographing apparatus) of the present invention includes an image processor and a white balance adjuster.

The image processor includes an optical system (OPS: OPtical System) having a plurality of lens groups (202, 203, and 204), a complementary metal-oxide-semiconductor (CMOS) 205, a correlation double sampler and analog-to-digital converter (CDS-ADC) 206, a digital signal processor (DSP) 207, and a controller 201.

The white balance adjuster includes PWB button 11 used as an input unit of a user, controller 201 generating a control signal according to an input of PWB button 11, and lens cover 14 which is driven under control of controller 201 and used as a white balance adjusting filter of the present invention.

Light incident from a subject is optically processed by the OPS. For example, the OPS includes a zoom lens unit 202, a focus lens unit 203, and an iris lens unit 204 that is a compensating lens. The zoom lens unit 202 is driven by a zoom driving and sensing unit 208. The focus lens unit 203 is driven by a focus driving and sensing unit 209. The CMOS 205 functions as a photoelectric transformer which transforms light flowing through the OPS into an electrical analog signal.

The CDS-ADC 206 removes high frequency noise from the electrical analog signal, adjusts the amplitude of the electrical analog signal, and converts the electrical analog signal into a digital signal.

The DSP 207 processes the digital signal output from the CDS-ADC 206 to generate a digital image signal which is divided into luminance and chromaticity signals. In this case, the DSP 207 controls a timing circuit (not shown) to control operations of the CMOS 205 and the CDS-ADC 206.

A white balance is controlled by the controller 201 which is a micro processor. In other words, the controller 201 generates a control signal for setting white balance data and a control signal for imaging a subject according to a signal input through PWB button 11 in order to control an overall operation of the digital camera. The controller 201 controls a lens cover driving and sensing unit 221 to close lens cover 14 when the signal input through PWB button 11 is sensed, so as to function as a gray card having a reflectance of 18%.

The DSP 207 stores an image signal of the subject as a reference value according to a PWB adjustment control signal and a subject photographing control signal of the controller 201 and operates the reference value on an image signal of a subject, which is imaged and input through a light source, in order to adjust a white balance.

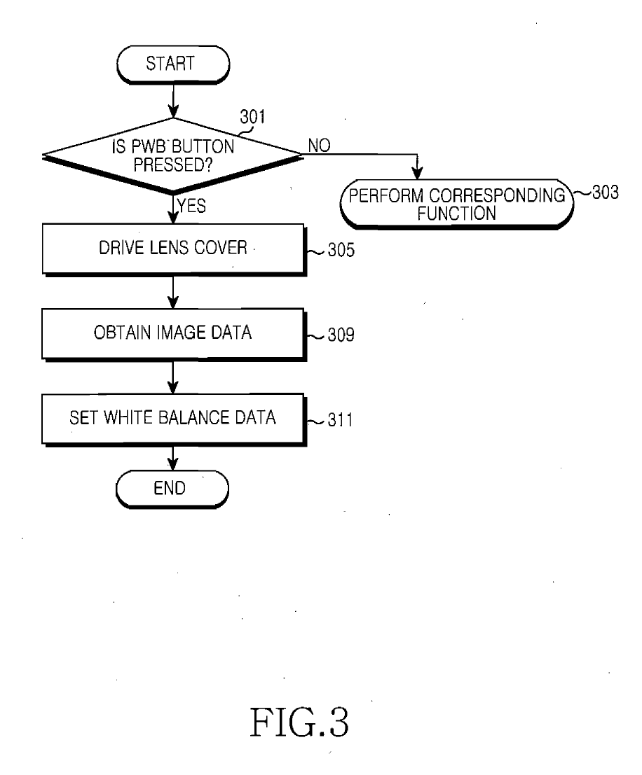

A method of setting (adjusting) custom white balance data of an image photographing apparatus having the above-described structure to adjust and operate a PWB will now be described with reference to FIG. 3.

Referring to FIG. 3, in step 301, the controller checks whether a signal is input through the PWB button. In this case, the digital camera will be placed in the direction toward a subject. Also, the digital camera is powered on, and the lens cover is open. If the signal is not input through the PWB button in step 301, the controller performs a corresponding function in step 303. If the signal is input through the PWB button in step 301, the controller drives the lens cover in step 305. In other words, the lens cover may be closed to cover a lens unit of the digital camera. This is because the lens cover is formed of an LCD light guide plate having a reflectance of 18% to function as a known gray card. In step 309, the controller photographs the subject to obtain image data. In step 311, the controller sets accurate white balance data using the obtained image data.

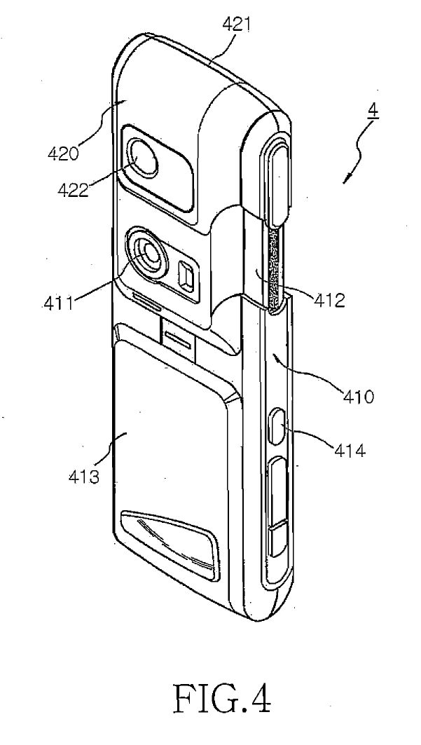

FIG. 4 is a perspective view of the rear side of a portable terminal 4 to which a lens cover is applied, i.e., a portable terminal including a digital camera having a manually operated lens cover, according to the present invention. Referring to FIG. 4, a popup type terminal 4 includes a main body 410 and a popup body 420 having a lens cover 422. The popup body 420 pops up and down from the main body 210 in a longitudinal direction of the popup type terminal 4. However, the present invention may be applied to various open type terminals which include digital cameras having lens covers.

A battery pack 413 as a power supply unit is provided on a rear surface of the main body 410, and a lens 411 of the digital camera is installed above the battery pack 413. The popup body 420 vertically moves along a guide bar 412 formed on a side of the main body 410, and the lens cover 422 is installed in an appropriate place of the popup body 420. If the popup body 420 is closed, the lens cover 422 may be used to protect the lens 411.

The lens cover 422 may be formed of an LCD light guide plate according to the present invention. Here, a user closes the popup body 420 so that the lens cover 422 protects the lens 411, in order to adjust a custom white balance. Thereafter, a white balance adjusting button 414 provided in an appropriate place of the main body 410 may be pressed to obtain image data and then an improved white balance value based on the image data.

In more detail, if the white balance adjusting button 414 is pressed, the controller checks whether a lens cover is opened or closed. If the lens cover is closed, the controller drives an image processor to set a corresponding white balance. However, if the lens cover is opened, the controller transmits request information to close the lens cover to a user through various output units of the image photographing apparatus. For example, the image photographing apparatus may further include a display device or a voice output apparatus to transmit a request to close the lens cover to the user. If the lens cover is closed, subsequent processes as described above may be performed.

In accordance with the present invention as described above, a white balance adjusting filter can be constituted in a lens cover as a component of an image photographing apparatus. Thus, the lens cover can be prevented from being lost due to its being carried separately. Also, since an improved white balance value can be obtained using a simple method, the image photographing apparatus can be reliably realized.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for adjusting a custom white balance, comprising:
an image processor processing an image obtained from a subject;
a controller controlling the image processor and setting a white balance value according to an input signal of a user, and
a lens cover protecting a portion of the image processor and used as a compensating filter when the custom white balance is adjusted.

2. The apparatus of claim 1, wherein the image processor comprises:
an optical system processing light flowing from the subject;
a complementary metal-oxide semiconductor (CMOS) transforming an image input from the optical system into an electrical analog signal;
a correlation double sampler and analog-to-digital converter (CDS-ADC) converting the electrical analog signal into a digital signal; and
a digital signal processor (DSP) processing the digital signal to generate luminance and chromaticity signals.

3. The apparatus of claim 1, wherein the lens cover is a liquid crystal display (LCD) light guide plate having a reflectance of about 18%.

4. The apparatus of claim 1, further comprising a lens cover driving and sensing unit for selectively and automatically opening and closing the lens cover under the control of the controller.

5. The apparatus of claim 3, further comprising a lens cover driving and sensing unit for selectively and automatically opening and closing the lens cover under the control of the controller.

6. The apparatus of claim 1, wherein the lens cover is manually opened and closed by a user.

7. The apparatus of claim 3, wherein the lens cover is manually opened and closed by a user.

8. The apparatus of claim 1, further comprising a preset white balance (PWB) button receiving an input signal for adjusting the custom white balance from a user.

9. The apparatus of claim 5, further comprising a PWB button receiving an input signal for adjusting the custom white balance from a user.

10. The apparatus of claim 9, wherein if the PWB button is pressed, the controller closes the lens cover.

11. A method of adjusting a custom white balance of an image photographing apparatus comprising an image processor processing an image obtained from a subject, a controller controlling the image processor and setting a white balance value according to an input signal of a user, and a lens cover protecting a portion of the image processor and used as a compensating filter when the custom white balance is adjusted, the method comprising:
checking whether a signal for adjusting a preset white balance (PWB) is input;
if the signal is input, closing the lens cover; and
obtaining image data of a subject and setting improved white balance data using the obtained image data.

12. The method of claim 11, wherein the lens cover has a light reflectance of about 18%.

13. The method of claim 11, wherein the lens cover is formed of an LCD light guide plate capable of adjusting a reflectance of light.

14. The method of claim 11, wherein the checking whether the signal for adjusting the PWB is input includes checking whether an additional button of the image photographing apparatus is pressed.

15. A method of adjusting a custom white balance of an image photographing apparatus comprising an image processor processing an image obtained from a subject, a controller controlling the image processor and setting a white balance value according to an input signal of a user, and a lens cover protecting a portion of the image processor and used as a compensating filter when the custom white balance is adjusted, the method comprising:
checking whether a signal for adjusting a preset white balance (PWB) is input;
if the signal is input, checking whether the lens cover is opened or closed; and
if the lens cover is closed, obtaining image data of a subject and setting improved white balance data using the obtained image data.

16. The method of claim 15, if the lens cover is opened, further comprising providing information as to a request to close the lens cover to a user.

17. The method of claim 16, wherein the information is one of visual information obtained by a display device of the image photographing apparatus and acoustic information obtained by a voice output apparatus of the image photographing apparatus.

18. The method of claim 15, wherein the lens cover has a light reflectance of about 18%.

19. The method of claim 15, wherein the lens cover is formed of an LCD light guide plate capable of adjusting a reflectance of light.

20. The method of claim 15, wherein the checking whether the signal for adjusting the PWB is input includes checking whether an additional button of the image photographing apparatus is pressed.
